(19) United States
(12) Patent Application Publication
(10) Pub. No.: US 2006/0240372 A1
(43) Pub. Date: Oct. 26, 2006

(54) Panel-type workpiece heater

(75) Inventor: Detlev Gertitschke, Laupheim (DE)

Correspondence Address: THE FIRM OF KARL F ROSS, 5676 RIVERDALE AVENUE, PO BOX 900, RIVERDALE (BRONX), NY, 10471-0900, US

(73) Assignee: UHLMANN Pac-Systeme GmbH & Co. KG

(21) Appl. No.: 11/407,406

(22) Filed: Apr. 19, 2006

(30) Foreign Application Priority Data
Apr. 21, 2005 (DE) 102005018652.1

(51) Int. Cl. F27B 9/28

(52) U.S. Cl. 432/59

(57) ABSTRACT

A heater for heating a generally flat workpiece has a generally flat support, a uniform array of individual small heat sources on the support, and respective switches for the sources. Respective conductors connect the switches to the sources, and a controller connected to the switches individually energizes the heat sources.

### FIELD OF THE INVENTION

The present invention relates to a heater. More particularly this invention concerns a heater intended to heat a generally flat workpiece.

### BACKGROUND OF THE INVENTION

Such heaters are used for example in thermoforming machines to heat a thermoshapable foil, transported from a supply roll through the individual stations of a thermoforming machine, to a processing temperature for a forming or sealing station.

With a batch-type or continuous mode of operation of the thermoforming machine, heaters are required that can also operate discontinuously or continuously, i.e. that can heat the workpieces to be heated correspondingly discontinuously or continuously. It is therefore known to use contact heating plates that are applied to one or both sides of the workpiece, or to use radiant heaters for a contact-free mode of operation that does not effect the heat input substantially by heat conduction but by heat radiation. Since with these known heaters still a certain given area is heated, which results from the geometric dimensions of the heater, it is to be considered as a format part, which has to be exchanged with high costs in case of format changes, i.e. changes of the dimensions of the workpiece to be heated.

Alternatively there is also the possibility to design a corresponding heater format-neutral, i.e. to provide the heat input into the largest area to be heated and to accept that with workpieces of smaller dimensions heat energy is emitted offset from the workpiece and is wasted as a result.

### OBJECTS OF THE INVENTION

It is therefore an object of the present invention to provide an improved panel-type workpiece heater.

Another object is the provision of such an improved panel-type workpiece heater that overcomes the above-given disadvantages, in particular that can be adjusted flexibly to different dimensions of the workpiece to be heated with low mechanical complexity and low costs for format changing.

### SUMMARY OF THE INVENTION

According to the invention the heat sources are arranged uniformly inn the grid pattern and each of the heat sources is connected via a conductor to a switch for flexibly switching the operational state independently from the other heat sources.

This design has the advantage that an area can be defined in the heater that correlates to the size of the workpiece to be heated and is used for the heating of the current workpiece, while heat sources that cannot be effective on the workpiece are not activated and thus neither waste energy nor create negative thermal effects. It is to be noted further that this heater can be combined both with batch-type as well as continuously operating machines. This device an especially silent mode of operation, as no mechanical adjustments are required that have to be controlled by drives or stops.

It is especially preferred in the scope of the invention that the heat sources be formed by radiant heaters. It is further provided that the radiant heaters are designed as spot radiators, i.e. heaters where substantially all the heat radiation starts from one point so that geometrically simple conditions are present where no heat radiating areas are to be taken into account with regard to their interaction with the radiation of adjacent heat sources.

Since with a spot-shaped radiation of heat energy in a given distance, a circular area is irradiated from the radiating spot, according to invention a mask with a rectangular aperture is arranged in front of each of the radiant heaters to achieve a consistent heating of the workpiece without heating gaps and especially also without overlapping adjacent circles.

It is especially preferred in the scope of the invention, if several adjacent heat sources are combined in groups for group-wise switching through the switches and controllers. In this embodiment a group of heat sources can be combined directed according to the dimensions of the workpiece such that switching between the operational states is simplified, as not many heat sources are to be managed independently from each other.

To achieve a simple constructive configuration the heat sources are arranged on a support plate as heating plate. Hence, in a simple design there is the possibility that the heating plate is planar, which is especially suggested, if the workpiece to be heated is also on a plane into the heater. Moreover due to the plurality of used heat sources arranged at a spacing from each other there is also the possibility that the heating plate can be curved, from which a plurality of further possibilities of use results for the heater and for its positioning in a larger machine environment.

Also preferred with respect to the simplicity of configuration is an embodiment, in which the conductors are formed through the leads for voltage supply of the heat sources.

### BRIEF DESCRIPTION OF THE DRAWING

The above and other objects, features, and advantages will become more readily apparent from the following description, reference being made to the accompanying drawing in which:

FIG. 1 is a perspective view of the heater according to invention;

FIG. 2 is a partly diagrammatic top view of the lower heating plate of the FIG. 1 heater; and

FIG. 3 is a large-scale edge view of a detail of the heater.

### SPECIFIC DESCRIPTION

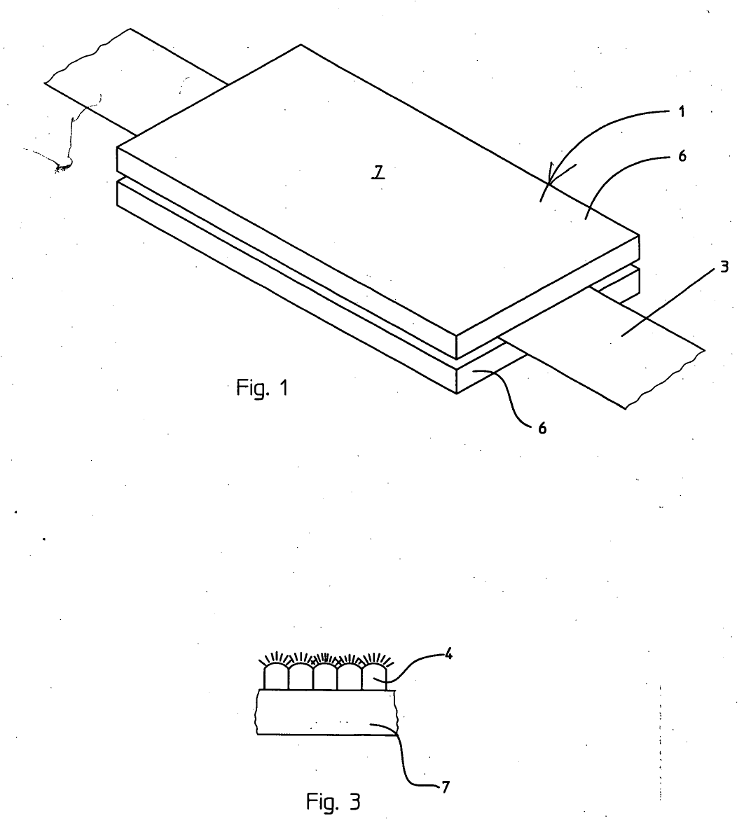

As seen in FIG. 1 a heater 1 is designed to heat broad flat workpieces 2 such as a thermoplastic foil 3 that is fed in a thermoforming machine not shown in the drawing to the heater 1 to preheat the foil 3. Further there is the possibility to use such a heater 1 upstream the sealing station of the thermoforming machine. Use of such a heater 1 is not limited to thermoforming machines with the heating of thermoplastic foils 3, but also plates or other broad flat workpieces 2.

This heater 1 has a plurality of heat sources 4 arranged adjacent the workpiece 2. The heat sources 4 according to invention are arranged uniformly as a grid 5. Each of the heat sources 4 is connected via a conductor 8 to a switch 9 for flexibly switching the operational state independently from the other heat sources 4, with the switches 9 in turn connected to a controller 10. These conductors 8 are by the leads for supplying current to the heat sources 4.

With this design the advantageous possibility results that depending on the area and the dimensions of the workpiece 2 to be heated the active area of the heater 1 actually used for heating the workpiece 2 can be defined. In the heater 1 the heat sources 4 are arranged on a support plate as heating plate 7. Two such plates 7 are provided, each with a grid 5 of sources 4 and spaced apart so that the workpiece 2 can be passed between them. In the illustrated embodiment the heat sources 4 are formed by NIR radiant heaters acting as spot radiators. In the shown embodiment further the heating plate 7 is planar, although the basic configuration of the heater 1 can also be curved or flexible.

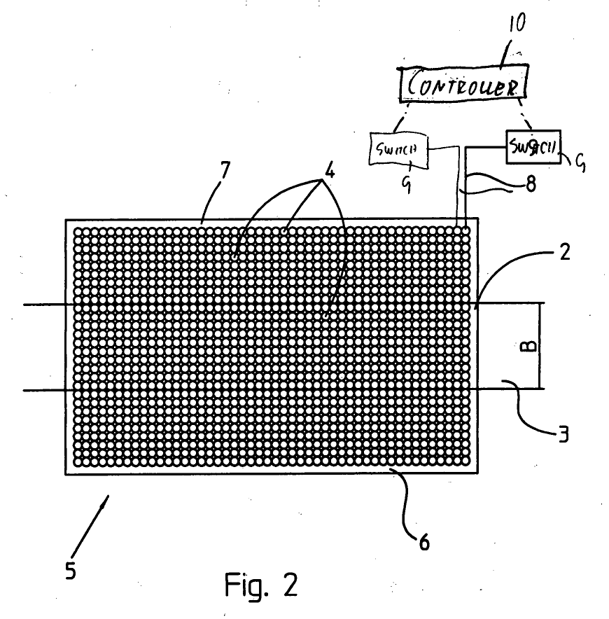

FIGS. 2 and 3 show schematically the application with a workpiece 2 whose width is less than the width of the heating plate 7. To prevent the use of heat sources 4 that cannot add effectively to the heating of the workpiece 2, the heat sources 4, arranged directly above and below the workpiece 2, are combined in a group and are all energized through the respective switches 9 by the controller 10, while the heat sources 4 lying offset from the workpiece 2 are switched off.

I claim:

1. A heater for heating a generally flat workpiece, the heater comprising:
a generally flat support;
a uniform array of individual small heat sources on the support;
respective switches for the sources;
respective conductors connecting the switches to the sources; and
a controller connected to the switches for individually energizing the heat sources.

2. The heater defined in claim 1 wherein the heat sources are radiant heaters.

3. The heater defined in claim 2 wherein the radiant heat sources are spot heaters.

4. The heater defined in claim 2, further comprising
a mask with a rectangular aperture positioned in front of each heater.

5. The heater defined in claim 1 wherein the heat sources are energized in groups.

6. The heater defined in claim 1 wherein the support is a rigid plate.

7. The heater defined in claim 6 wherein the plate has a planar face carrying the sources.

8. The heater defined in claim 6 wherein the plate is curved.

9. The heater defined in claim 1 wherein the conductors are electric supply lines for the sources.

10. The heater defined in claim 1 wherein the sources are NIR radiators.
